(19) United States
(12) Patent Application Publication
(10) Pub. No.: US 2009/0112580 A1
(43) Pub. Date: Apr. 30, 2009

(54) Speech processing apparatus and method of speech processing

(75) Inventors: Gou Hirabayashi, Kanagawa (JP); Dawei Xu, Tokyo (JP); Takehiko Kagoshima, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/219,385

(22) Filed: Jul. 21, 2008

(30) Foreign Application Priority Data
Oct. 31, 2007 (JP) 2007-282944

(51) Int. Cl. G10L 19/14

(52) U.S. Cl. 704/205; 704/E19.001

(57) ABSTRACT

The speech processing apparatus configured to split a first speech waveform and a second speech waveform into a plurality of frequency bands respectively to generate a first band speech waveform and a second band speech waveform each being a component of each frequency band; determine an overlap-added position between the first band speech waveform and the second band speech waveform by the each frequency band so that a high cross correlation between the first band speech waveform and the second band speech waveform is obtained; and overlap-add the first band speech waveform and the second band speech waveform by the each frequency band on the basis of the overlap-added position and integrates overlap-added band speech waveforms in the plurality of frequency bands over all the plurality of frequency bands to generate a concatenated speech waveform.

### CROSS-REFERENCE TO RELATED APPLICATIONS

This application is based upon and claims the benefit of priority from the prior Japanese Patent Application No.2007-282944, filed on Oct. 31, 2007; the entire contents of which are incorporated herein by reference.

### TECHNICAL FIELD

The present invention relates to text speech synthesis and, more specifically, to a speech processing apparatus for generating synthetic speech by concatenating speech units and a method of the same.

### BACKGROUND OF THE INVENTION

In recent years, a text speech synthesizing system configured to generate speech signals artificially from a given sentence has been developed. In general, such text speech synthesizing system includes three modules of; a language processing unit, a prosody generating unit, and a speech signal generating unit.

When a text is entered, the language processing unit performs mode element analysis or syntax analysis of the text, then the prosody generating unit generates prosody and intonation, and then phonological sequence and prosody information (fundamental frequency, phonological duration length, power, etc.) are outputted. Finally, the speech signal generating unit generates speech signals from the phonological sequence and prosody information, so that a synthesized speech for the entered text is generated.

As a known speech signal generating unit (so-called speech synthesizer), there is a concatenative (unit-overlap-adding) speech synthesizer as shown in FIG. 2, which selects speech units from a speech unit dictionary in which a plurality of speech units (units of speech waveform) are stored on the basis of the phonological sequence and prosody information and generates a desired speech by concatenating the selected speech units.

In order to make the spectrum to be changed smoothly at concatenation portions of the speech units, this concatenative speech synthesizer normally weights part or all the plurality of speech units to be concatenated and overlap-adds the same in the direction of time axis as shown in FIG. 17B. However, when the phases of the speech unit waveforms of the individual units to be concatenated are different, an in-between spectrum cannot be generated only by simply overlap-adding the units, and changes of the spectrum are discontinued, thereby resulting in concatenation distortion.

Therefore, in the related art, in order to reduce the distortion due to the phase difference between the speech units, a method of calculating the cross correlation directly for the plurality of speech units to be overlap-added at the concatenation portions and shifting positions to overlap-add the speech units so as to get a high correlation is employed. FIGS. 18A and 18B show examples in which voiced portion of the speech unit is decomposed into the unit of pitch-cycle waveforms, and the pitch-cycle waveforms are overlap-added at a concatenation portion. FIG. 18A shows an example of a case in which the phase difference is not considered, and FIG. 18B shows a case in which the phase difference is considered and the two pitch-cycle waveforms to be overlap-added are shifted to obtain the maximum correlation.

There is also proposed a method of obtaining a synthesized speech in which the concatenation distortion due to the difference in shape of the speech waveform caused by the difference in phase by concatenating using phase-equalized speech to which phase equalization is applied in advance to an original speech waveform (phase-zeroising by removing linear phase component) is reduced (for example, see JP-A-8-335095).

However, the related art has following problems.

In the method of calculating the cross correlation directly for the plurality of speech units to be overlap-added and shifting the overlap-added position to get a high correlation, although the phases in the low-frequency band having a relatively high power are aligned, the phase displacement in the medium to high frequency having a low power is not corrected. Therefore, the phases are partly denied and part of the frequency band component is attenuated, so that the change of the spectrum at the concatenation portions is discontinued, whereby clarity and naturalness of the generated synthesized sound are deteriorated.

For example, a case in which a pitch-cycle waveform A and a pitch-cycle waveform B are overlap-added at a concatenation portion as shown in FIG. 8 is considered. The pitch-cycle waveform A and the pitch-cycle waveform B the each have a power spectrum having two peaks, have similar spectral shapes, but have different phase characteristics in the low-frequency band. When the cross correlation is directly calculated for the pitch-cycle waveform A and the pitch-cycle waveform B, and the overlap-added position is shifted to obtain the higher cross correlation, the phases in the low-frequency band having a relatively high power are aligned, but the phases in the high-frequency band are conversely shifted. Therefore, the high-frequency components are lost from the overlap-added pitch-cycle waveforms, and hence a waveform having an in-between spectrum between the pitch-cycle waveform A and the pitch-cycle waveform B cannot be generated with the method in the related art shown in FIG. 18A, so that a synthesized speech which changes smoothly at the concatenation portions cannot be obtained.

On the other hand, when the phase is forcedly aligned by shaping the original phase information of the speech waveform by the process such as phase zeroising or phase equalization, there arises a problem such that nasal sound which is specific for zero phase jars unpleasantly on the ear even when it is a voiced sound, in particular, in the case of the voiced affricate containing large amount of high-frequency components, so that deterioration of the sound quality cannot be ignored.

### BRIEF SUMMARY OF THE INVENTION

In view of such problems described above, it is an object of the invention to provide a speech processing apparatus in which discontinuity of spectrum change at concatenation portions is alleviated when overlap-adding speech waveforms at the concatenation portions.

According to embodiments of the present invention, there is provided a speech processing apparatus configured to overlap-add a first speech waveform as a part of a first speech unit and a second speech waveform as a part of a second speech unit to concatenate the first speech unit and the second speech unit, including: a splitting unit configured to split the first speech waveform into a plurality of frequency bands to generate a band speech waveform A being a component of each frequency band, and split the second speech waveform into a plurality of frequency bands to generate a band speech waveform B being a component of each frequency band; a position determining unit configured to determine an overlap-added position between the band speech waveform A and the band speech waveform B by the each frequency band so that a high cross correlation between the band speech waveform A and the band speech waveform B is obtained or so that a small difference in phase spectrum between the band speech waveform A and the band speech waveform B is obtained; and an integrating unit configured to overlap-add the band speech waveform A and the band speech waveform B by the each frequency band on the basis of the overlap-added position and integrate overlap-added band speech waveforms in the plurality of frequency bands over all the plurality of frequency bands to generate a concatenated speech waveform.

According to another embodiment of the invention, there is provided a speech processing apparatus including a first dictionary including a plurality of speech waveforms and reference points to be overlap-added when concatenating the speech waveforms stored therein for each speech waveform; a splitting unit configured to split the each speech waveform into a plurality of frequency bands and generate a band speech waveform as a component of the each frequency band; a reference waveform generating unit configured to generate a band reference speech waveform each containing a signal component of the each frequency band; a position correcting unit configured to correct the reference point for the band speech waveform so as to achieve a high cross correlation between the band speech waveform and the band reference speech waveform or so as to achieve a small difference in phase spectrum between the band speech waveform and the band reference speech waveform and obtaining a band reference point for the band speech waveform; and a reconfiguring unit configured to shift the band speech waveform to align the position of the band reference point and integrate shifted band speech waveforms over all the plurality of frequency bands to reconfigure the speech waveform.

According to the invention, the phase displacement between the speech waveforms to be overlap-added at the concatenation portion is reduced in all the frequency bands and, consequently, the discontinuity of the spectrum change at the concatenation portion is alleviated, so that a clear and natural synthesized sound is generated.

According to the invention, the phase displacement between the speech waveforms is reduced in all the frequency bands when creating the speech waveform dictionary, so that a clear and smooth synthesized sound is generated without increasing the throughput on-line.

### BRIEF DESCRIPTION OF THE DRAWINGS

FIG. 1 is a block diagram showing a configuration example of a concatenation section waveform generating unit according to a first embodiment of the invention;

FIG. 2 is a block diagram showing a configuration example of a concatenative speech synthesizer;

FIG. 3 is a flowchart showing an example of process procedure of a speech unit modifying/concatenating portion;

FIG. 4 is a schematic diagram showing an example of the process content of a speech unit modifying/concatenating portion;

FIG. 5 is a flowchart showing an example of process procedure of the concatenation section waveform generating unit;

FIG. 6 is a drawing showing an example of filter characteristics for bandsplitting;

FIG. 7 is a drawing showing an example of a pitch-cycle waveform and a low-frequency pitch-cycle waveform and a high-frequency pitch-cycle waveform obtained by bandsplitting the same;

FIG. 8 is a schematic drawing showing an example of process content according to a first embodiment;

FIG. 9 is an explanatory schematic drawing showing an example of process content according to a second embodiment;

FIG. 10 is a block diagram showing a configuration example of the concatenation section waveform generating unit;

FIG. 11 is a block diagram showing a configuration example of the concatenation section waveform generating unit according to Modification 2 in the second embodiment;

FIG. 12 is a block diagram showing a configuration example of a speech unit dictionary creating apparatus according to a third embodiment:

FIG. 13 is a flowchart showing an example of process procedure of the speech unit dictionary creating apparatus;

FIG. 14 is a schematic diagram showing an example of the process content;

FIG. 15 is a block diagram showing a configuration example of the speech unit dictionary creating apparatus according to Modification 4 in the third embodiment;

FIG. 16 is a drawing showing an example of the filter characteristics for bandsplitting in Modification 5 in the third embodiment;

FIG. 17 is an explanatory drawing of a process to overlap-add and concatenate speech units; and

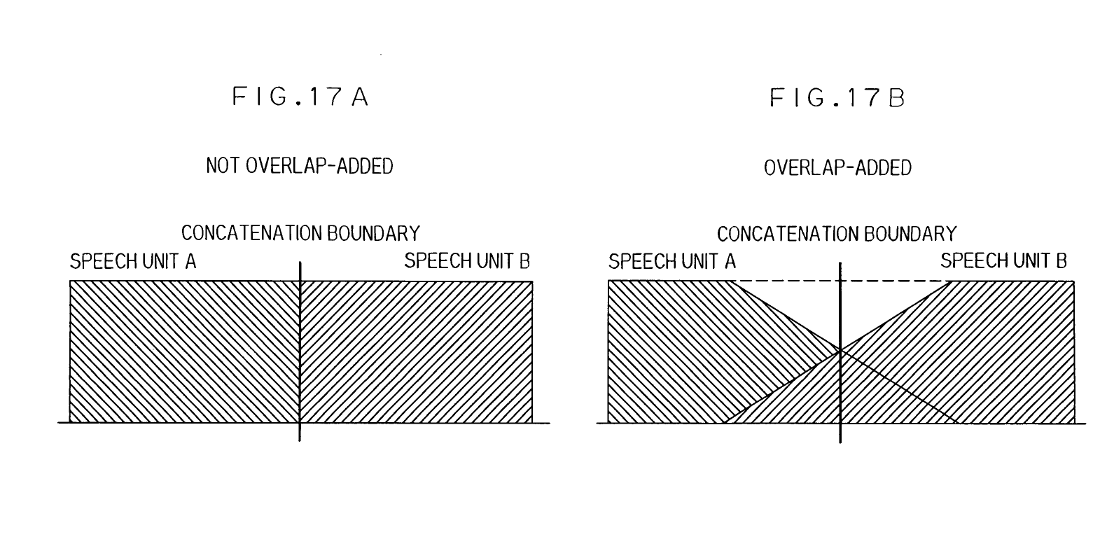

FIG. 18 is an explanatory drawing of a process to overlap-add considering the phase difference of the pitch-cycle waveforms.

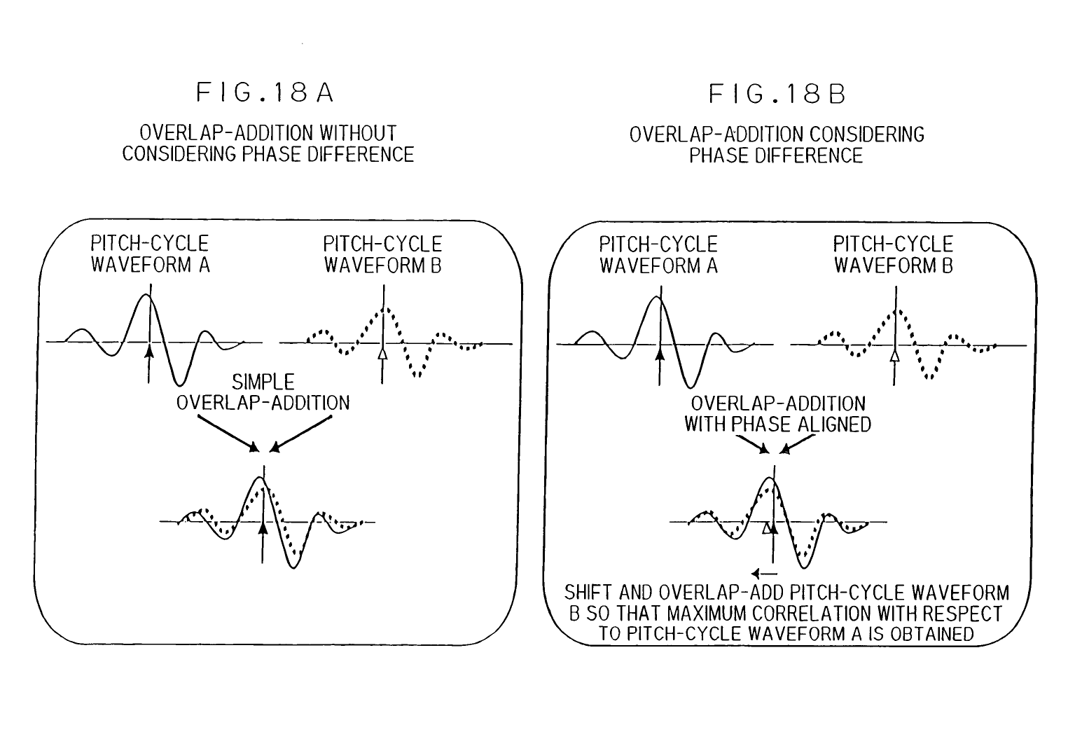

### DETAILED DESCRIPTION OF THE INVENTION

Referring now to the drawings, embodiments of the invention will be described in detail.

### First Embodiment

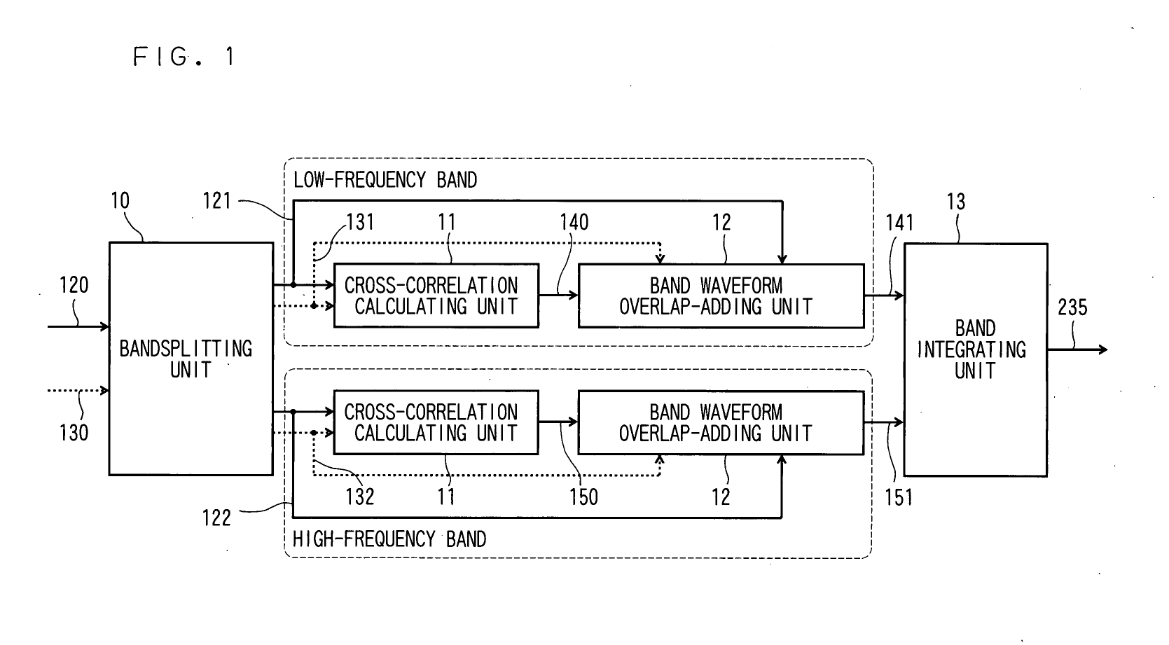

Referring now to FIG. 1 to FIG. 8, a concatenative speech synthesizer as an speech processing apparatus according to a first embodiment of the invention will be described.

### (1) Configuration of Concatenative Speech Synthesizer

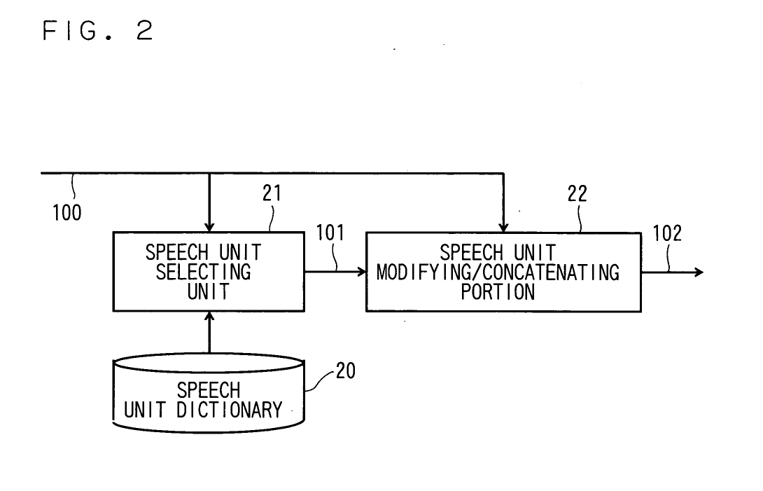

FIG. 2 shows an example of the configuration of a concatenative speech synthesizer as a speech processing apparatus according to the first embodiment.

The concatenative speech synthesizer includes a speech unit dictionary 20, a speech unit selecting unit 21, and a speech unit modifying/concatenating portion 22.

The functions of the individual units 20, 21 and 22 may be implemented as hardware. A method described in the first embodiment may be distributed by storing in a recording medium such as a magnet disk, an optical disk or a semiconductor memory or via a network as a program which is able to be executed by a computer. The functions described above may also be implemented by describing as software and causing a computer apparatus having a suitable mechanism to process the description.

The speech unit dictionary 20 stores a large amount of speech units in a unit of speech (unit of synthesis) used when generating a synthesized speech. The unit of synthesis is a combination of phonemes or fragments of phoneme, and includes semi phonemes, phonemes, diphones, triphones and syllables, and may have a variable length such as a combination thereof. The speech unit is a speech signal waveform corresponding to the unit of synthesis or a parameter sequence which represents the characteristic thereof.

The speech unit selecting unit 21 selects a suitable speech unit 101 from the speech units stored in the speech unit dictionary 20 on the basis of entered phonological sequence/prosody information 100 individually for a plurality of segments obtained by delimiting the entered phonological sequence by the unit of synthesis. The prosody information includes, for example, a pitch-cycle pattern, which is a change pattern of the voice pitch and the phonological duration.

The speech unit modifying/concatenating portion 22 modifies and concatenates the speech unit 101 selected by the speech unit selecting unit 21 on the basis of the entered prosody information and outputs a synthesized speech waveform 102.

### (2) Process in Speech Unit Modifying/Concatenating Portion 22

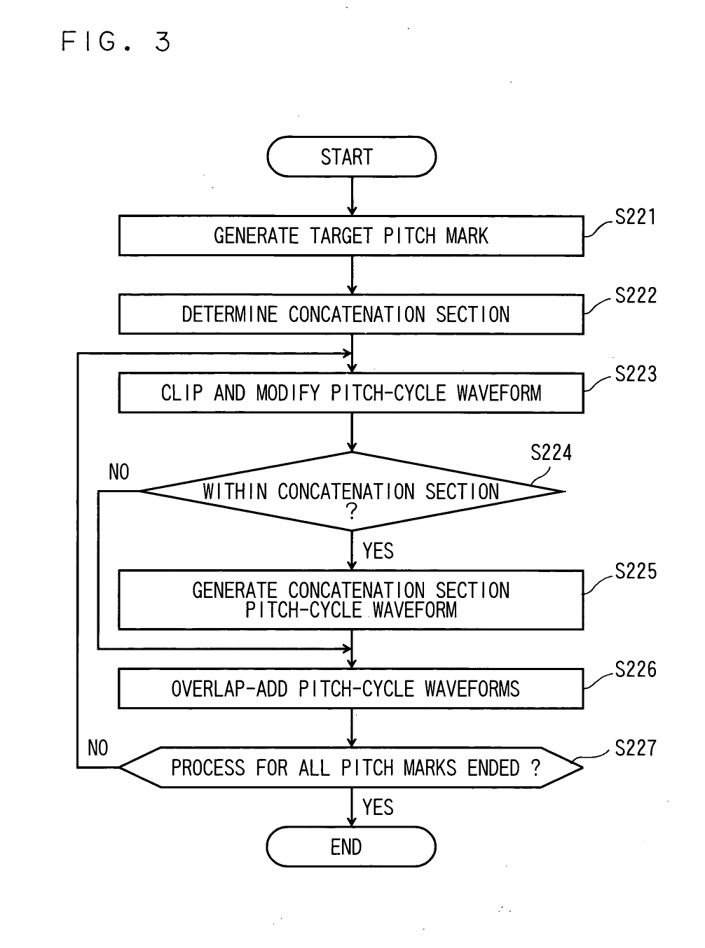

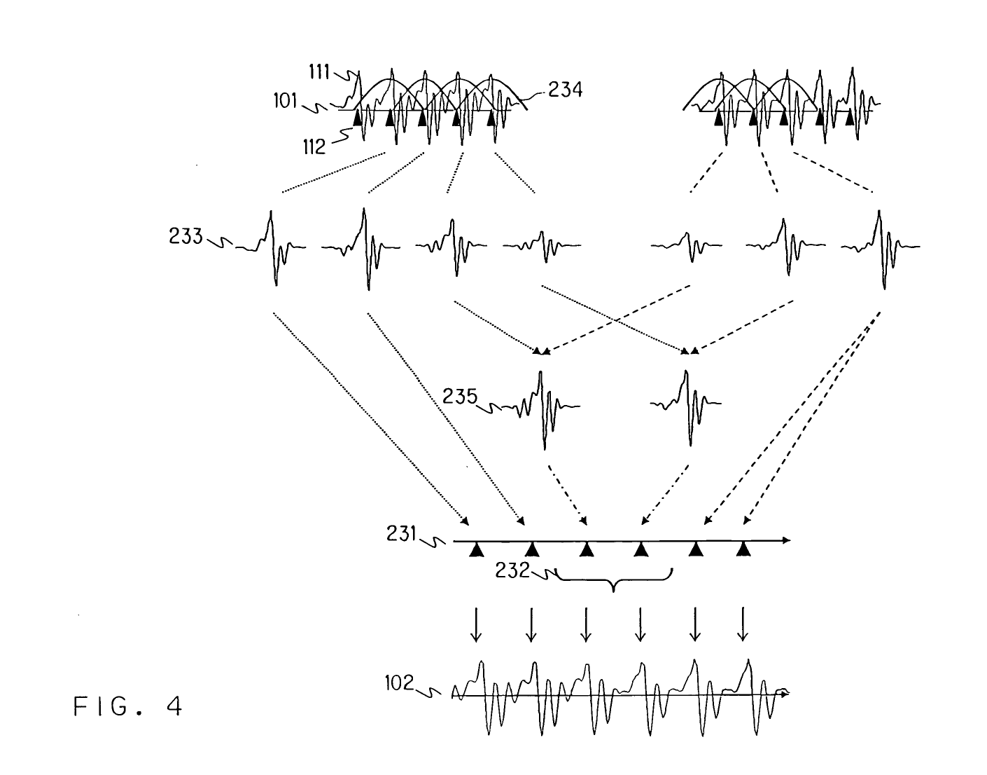

FIG. 3 is a flowchart showing a process flow carried out in the speech unit modifying/concatenating portion 22. In this specification, a case of clipping pitch-cycle waveforms individually from the speech units, and overlap-adding these pitch-cycle waveforms on a time axis to generate a synthesized speech waveform will be described as an example. FIG. 4 is a pattern diagram showing a sequence of this process.

In this specification, a term “pitch-cycle waveform” represents a relatively short speech waveform having a length on the order of several times of the fundamental frequency of the speech at the maximum and having no fundamental frequency by itself, whose spectrum represents a spectrum envelope of the speech signal.

Firstly, target pitch marks 231 as shown in FIG. 4 are generated from the phonological sequence/prosodyinformation. The target pitch mark 231 represents a position on the time axis where the pitch-cycle waveforms are overlap-added for generating the synthesized speech waveform, and the interval of the pitch marks corresponds to a pitch cycle (S221).

Subsequently, in order to concatenate the speech units smoothly, a concatenating section 232 to overlap-add and concatenate a precedent speech unit and a succeeding speech unit is determined (S222).

Subsequently, pitch-cycle waveforms 233 to be overlap-added respectively on the target pitch marks 231 are generated by clipping individual pitch-cycle waveforms from the speech unit 101 selected by the speech unit selecting unit 21, and modifying the same by changing the power considering the weight when overlap-adding as needed (S223).

Here, the speech unit 101 is assumed to include information of a speech waveform 111 and a reference point sequence 112, and the reference point is the one provided for every pitch-cycle waveform appeared cyclically on the speech waveform in the voiced sound portion of the speech unit and provided in advance at certain time intervals in the unvoiced sound portion. The reference points may be set automatically using various existing methods such as the pitch extracting method or the pitch mark mapping method, or may be mapped manually, and is assumed to be points which are synchronized with the pitches mapped for rising points or peak points of the pitch-cycle waveforms in the voiced sound portion. When clipping the pitch-cycle waveforms, for example, a method of applying a window function 234 having a window length of about two times the pitch cycle to around the reference points mapped to the speech unit.

Subsequently, in the case in which the target pitch mark is within the concatenation section, concatenation section pitch-cycle waveforms 235 are generated from the pitch-cycle waveforms clipped from the precedent speech unit and the pitch-cycle waveforms clipped from the succeeding speech unit (S225).

Finally, the pitch-cycle waveforms are overlap-added on the target pitch marks (S226).

The operation described above is repeated for all the target pitch marks to the end and the synthesized speech waveform 102 is outputted (S227).

### (3) General Description of Concatenation Section Waveform Generating Unit 1

Hereinafter, a configuration and a processing operation relating to concatenation section waveform generating unit 1 as a characteristic portion of the first embodiment and also as part of the speech unit modifying/concatenating portion 22 will mainly be described in further detail.

The concatenation section waveform generating unit 1 is a section to perform a process of generating the pitch-cycle waveforms 235 for overlap-adding on the concatenation sections by overlap-adding the plurality of pitch-cycle waveforms (S225).

Here, a case of generating a concatenation section waveform to be overlap-added on a certain target pitch mark within the concatenation section for concatenating a precedent speech unit and a succeeding speech unit by each pitch-cycle waveform will be described as an example.

### (4) Configuration of Concatenation Section Waveform Generating Unit 1

FIG. 1 shows an example of the configuration of the concatenation section waveform generating unit 1.

The concatenation section waveform generating unit 1 includes a bandsplitting unit 10, a cross-correlation calculating unit 11, a band pitch-cycle waveform overlap-adding unit 12 and a band integrating unit 13.

### (4-1) Bandsplitting Unit 10

The bandsplitting unit 10 splits a first pitch-cycle waveform 120 extracted from the precedent speech unit to be overlap-added in the concatenation section and a second pitch-cycle waveform 130 extracted from the succeeding speech unit into a plurality of frequency bands, and generates band pitch-cycle waveforms A (here after being referred as band pitch-cycle waveforms 121,122) and band pitch-cycle waveforms B (here after being referred as band pitch-cycle waveforms 131,132) respectively.

A case of splitting into two bands; a high-frequency band and a low-frequency band, using a high-pass filter and a low-pass filter will be described here as an example.

### (4-2) Cross-Correlation Calculating Unit 11

The cross-correlation calculating unit 11 calculates the cross correlation of the band pitch-cycle waveforms generated respectively from the pitch-cycle waveforms to be overlap-added for the each band, and determines overlap-added positions 140 and 150 for the each band which has a largest coefficient of cross correlation within a certain search range.

### (4-3) Band Pitch-Cycle Waveform Overlap-adding Unit 12

The band pitch-cycle waveform overlap-adding unit 12 overlap-adds the band pitch-cycle waveforms for the each band according to the overlap-added position 140 or 150 determined by the cross-correlation calculating unit 11, and outputs band overlap-added pitch-cycle waveforms 141 and 151 which are obtained by overlap-adding the components of the individual bands of the pitch-cycle waveforms to be overlap-added.

### (4-4) Band Integrating Unit 13

The band integrating unit 13 integrates band overlap-added pitch-cycle waveforms 141 and 151, which are overlap-added by the each band, and outputs the concatenation section pitch-cycle waveform 235 to be overlap-added on a certain target pitch mark within the concatenation section.

### (5) Processing in Concatenation Section Waveform Generating Unit 1

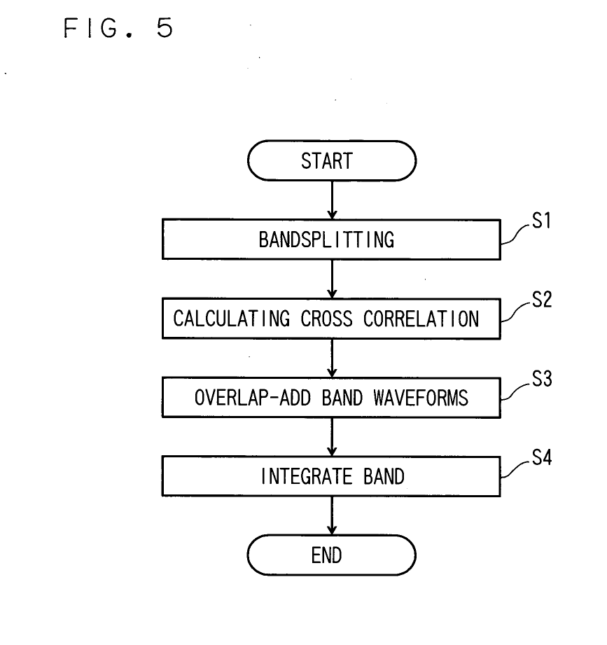

Subsequently, each processing performed by the concatenation section waveform generating unit 1 will be described in detail using a flowchart showing a flow of processing in the concatenation section waveform generating unit 1 in FIG. 5.

### (5-1) Step S1

Firstly, in Step S1, the bandsplitting unit 10 splits the pitch-cycle waveform 120 extracted from the precedent speech unit and the pitch-cycle waveform 130 extracted from the succeeding speech unit into a plurality of frequency bands, respectively, to generate band pitch-cycle waveforms.

Here, since the case of splitting into two bands; the high-frequency band and the low-frequency band is taken as an example, low-frequency band components are extracted from the pitch-cycle waveform 120 and the pitch-cycle waveform 130 using the low-pass filter to generate the low-frequency pitch-cycle waveforms 121 and 131 respectively, and high-frequency band components are extracted from the pitch-cycle waveform 120 and the pitch-cycle waveform 130 using the high-pass filter to generate the high-frequency pitch-cycle waveforms 122 and 132, respectively.

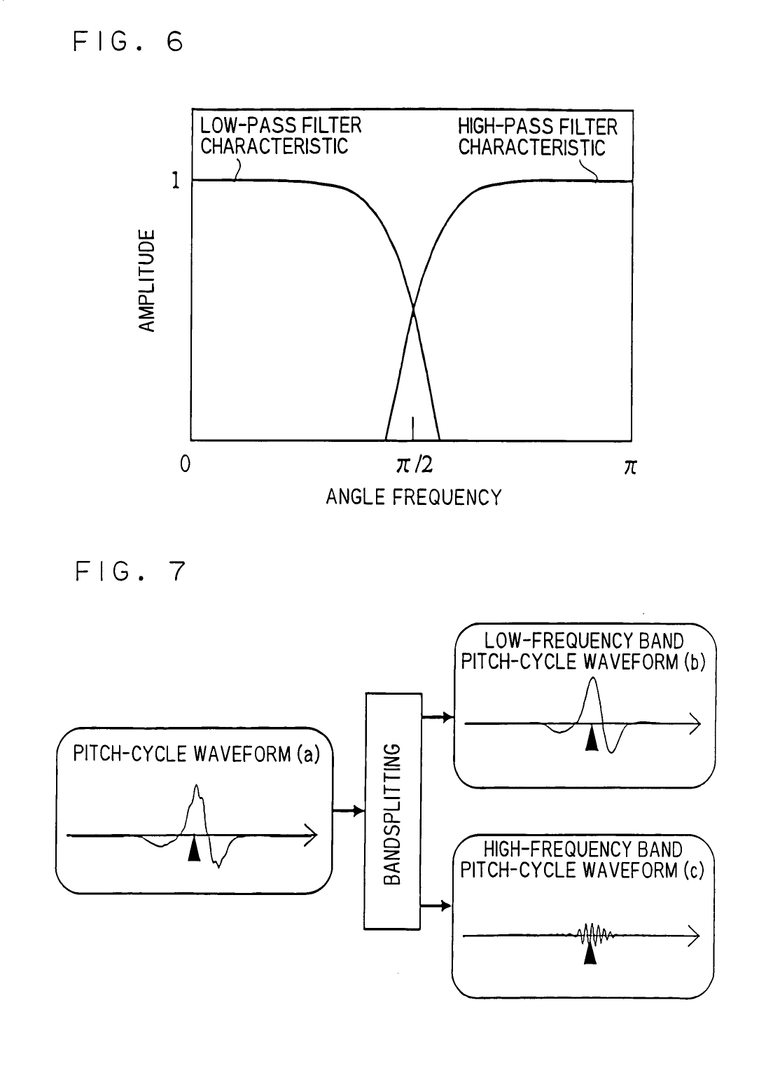

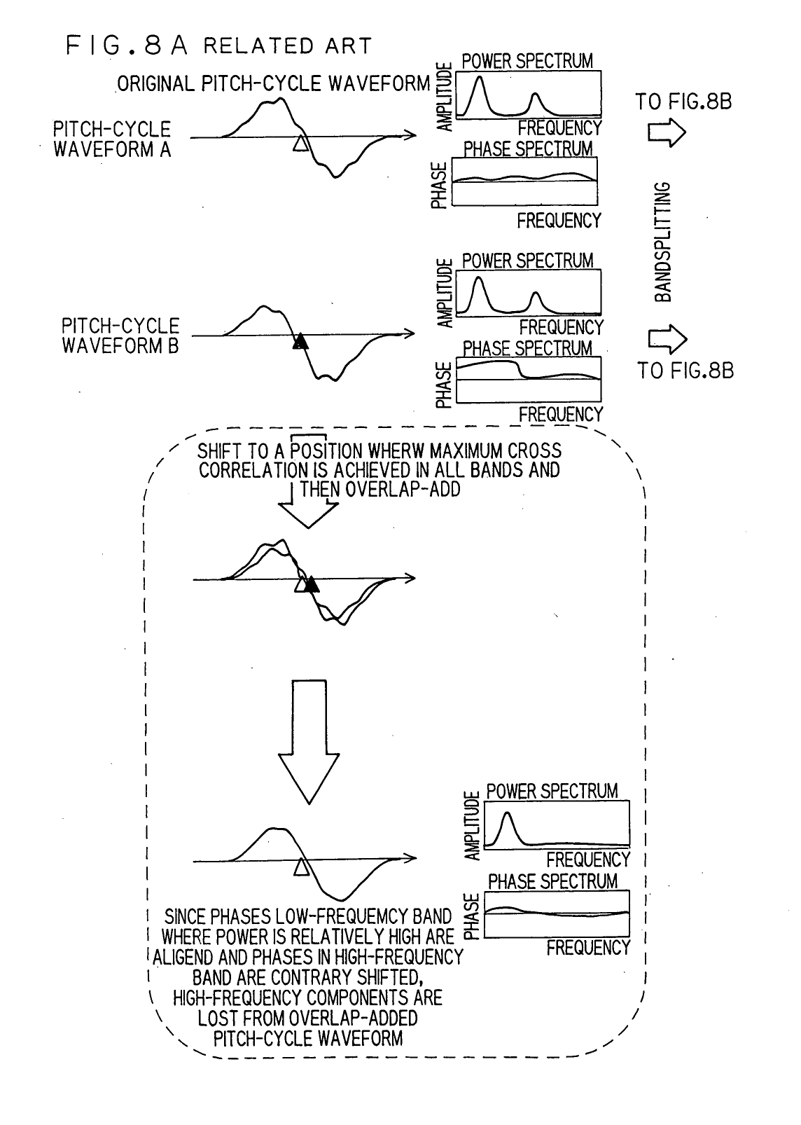

FIG. 6 shows the frequency characteristics of the low-pass filter and the high-pass filter. FIG. 7 shows examples of a pitch-cycle waveform (a) and a low-frequency pitch-cycle waveform (b) and a high-frequency pitch-cycle waveform (c) corresponding thereto.

As described above, the band pitch-cycle waveforms 121, 122, 131 and 132 are generated from the pitch-cycle waveform 120 and the pitch-cycle waveform 130 respectively, and then the procedure goes to Step S2 in FIG. 5.

### (5-2) Step S2

Subsequently, in Step S2, the cross-correlation calculating unit 11 calculates the cross correlation of the band pitch-cycle waveforms generated from the precedent speech unit and the succeeding speech unit to be overlap-added respectively for the each band and determines the overlap-added positions 140 and 150 for the each band which has the highest cross correlation.

In other words, the cross-correlation calculating unit 11 calculates the cross correlation of the individual band pitch-cycle waveforms of the low-frequency band and the high-frequency band separately for the each band, and determines the overlap-added position where a high cross correlation of the band pitch-cycle waveforms from the two speech units to be overlap-added is achieved, that is, where the displacement of the phases in the each band is small.

As an example, in a certain band, what has to be done to determine the overlap-added position by calculating an adequate shift width of the reference point of the band pitch-cycle waveform generated from the succeeding speech unit with respect to the reference point of the band pitch-cycle waveform generated from the precedent speech unit is to calculate a value k which increases:

$$C ( k ) = {\sum }_{t = 0}^{N} px ( t ) \cdot py ( t + k ) , - K \leq k \leq K$$

where px(t) is a band pitch-cycle waveform signal of the precedent speech unit, py(t) is a band pitch-cycle waveform signal of the succeeding speech unit, N is a length of the band pitch-cycle waveform for calculating the cross correlation, and K is a maximum shift width for determining the range for searching the overlap-added position.

As described above, after having calculated the cross correlation between the band pitch-cycle waveforms and having outputted the overlap-added positions 140 and 150 which reduce the displacement of the overlap-added phases for the each band, the procedure goes to Step S3 in FIG. 5.

### (5-3) Step S3

Subsequently, in Step S3, the band pitch-cycle waveform overlap-adding unit 12 overlap-adds the band pitch-cycle waveforms 121 and 131, or 122 and 132 according to the overlap-added position 140 or 150 determined by the cross-correlation calculating unit 11 in the each band, and outputs the band overlap-added pitch-cycle waveforms 141 and 151 which are waveforms obtained by overlap-adding the components of the each band of the pitch-cycle waveforms in the concatenation section.

In other words, the band overlap-added pitch-cycle waveform 141 of the low-frequency band is generated by overlap-adding the band pitch-cycle waveforms 121 and 131 according to the overlap-added position 140 and the band overlap-added pitch-cycle waveform 151 of the high-frequency band is generated by overlap-adding the band pitch-cycle waveforms 122 and 132 according to the overlap-added position 150.

Accordingly, a band overlap-added pitch-cycle waveform having an in-between spectrum having a small distortion due to the phase difference between the overlap-added pitch-cycle waveforms is obtained in the each band.

As described above, after having outputted the band overlap-added pitch-cycle waveforms 141 and 151, which are waveforms obtained by overlap-adding a plurality of the speech units for the concatenation section for the each band, the procedure goes to Step S4 in FIG. 5.

### (5-4) Step S4

Subsequently, in Step S4, the band integrating unit 13 integrates the band overlap-added pitch-cycle waveform 141 of the low-frequency band and the band overlap-added pitch-cycle waveform 151 of the high-frequency band, and outputs the concatenation section pitch-cycle waveform 235 to be overlap-added on a certain target pitch mark in the concatenation section.

### (6) Advantages

As described above, according to the first embodiment, when overlap-adding the plurality of pitch-cycle waveforms in the concatenation section of the speech units, the pitch-cycle waveforms to be overlap-added in the bandsplitting unit 10 are each split into a plurality of frequency bands, and the phase alignment is carried out by the each band by the cross-correlation calculating unit 11 and the band pitch-cycle waveform overlap-adding unit 12. Therefore, the phase displacement between the speech units used in the concatenation portion may be reduced in all the frequency band.

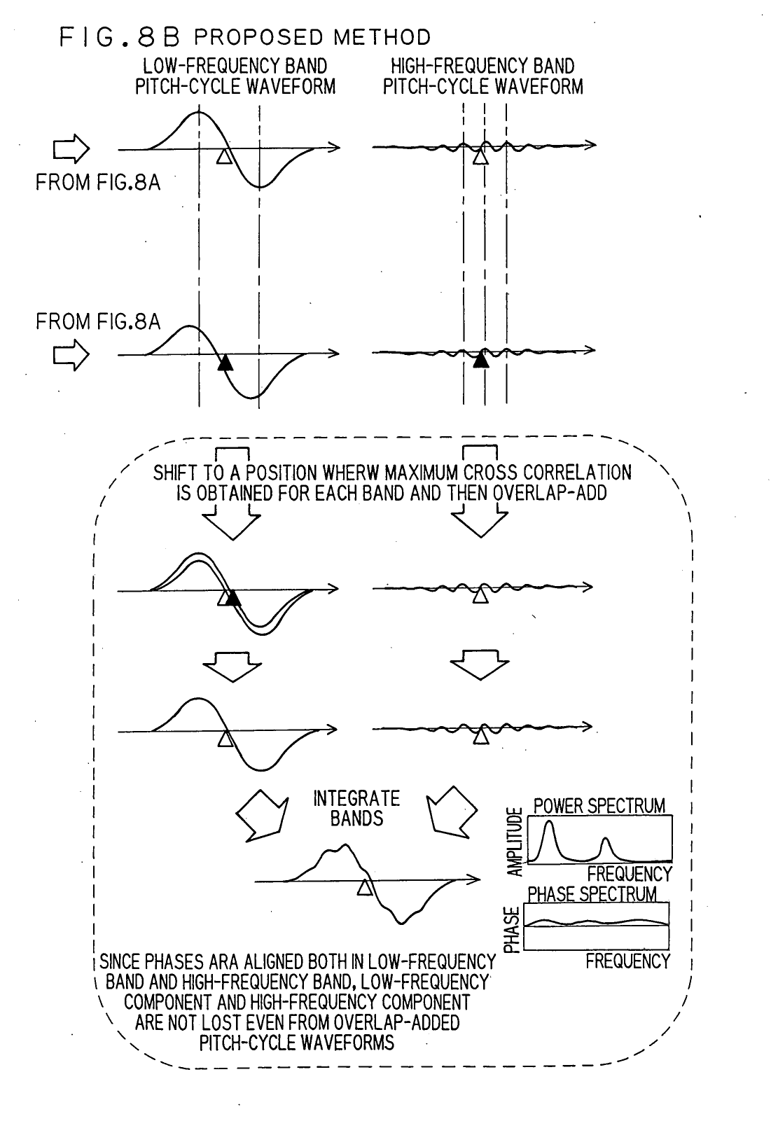

In other words, in comparison with a case in the related art shown in FIG. 8A in which the cross correlation are calculated directly for all the frequency bands to generate the concatenation section pitch-cycle waveforms, the overlap-added position is determined so as to achieve high cross correlations with respect to the waveforms split into the individual bands in FIG. 8B which schematically shows the operation in the first embodiment. Therefore, waveforms with smaller phase difference, having an in-between spectrum between the precedent speech unit and the succeeding speech unit for the concatenation section and hence having a small distortion due to the phase difference are generated for the low-frequency band and the high-frequency band, respectively.

By using the waveforms as described above, discontinuity of spectrum change at the concatenation portions is alleviated and, being different from the case in which the phases are aligned by the process such as phase zeoization, deterioration of the sound quality due to missing of the phase information is avoided, so that the clarity and naturalness of the generated synthesized sound are improved as a result.

### (7) Modification

### (7-1) Modification 1

In the first embodiment described above, the concatenation section pitch-cycle waveforms are generated in advance and are overlap-added on the target pitch marks in the concatenation section. However, the invention is not limited thereto.

For example, it is also possible to overlap-add the pitch-cycle waveform from the precedent speech unit on the target pitch mark in advance and, when overlap-adding the pitch-cycle waveform from the succeeding speech unit on the pitch-cycle waveform from the precedent speech unit in the concatenation section, shift the overlap-added position to achieve the high cross correlation for the periphery of the target pitch mark in the each band.

### (7-2) Modification 2

In the first embodiment, the pitch-cycle waveforms are clipped from the speech unit. However, the invention is not limited thereto.

For example, when the voiced speech unit stored in the speech unit dictionary 20 includes at least one pitch-cycle waveform, the pitch-cycle waveform may be generated by selecting the pitch-cycle waveform to be overlap-added to a corresponding target pitch mark from the speech unit and modifying by carrying out the process such as to change the power as needed instead of clipping the pitch-cycle waveforms from the speech unit selected in Step S233 in FIG. 3. The process steps from then onward may be the same as the first embodiment shown above.

The pitch-cycle waveform to be held as the speech unit is not limited to the waveforms obtained simply by clipping by applying the window function to the speech waveform, and may be those subjected to various modifications or convetion after having clipped.

### (7-3) Modification 3

In the first embodiment, the process such as the bandsplitting or the calculation of the cross correlation is applied to the pitch-cycle waveforms after having modified by, for example, changing the power (S223) considering the weighting at the time of overlap-addition. However, the process procedure is not limited thereto.

For example, the same effects are achieved also by applying the process such as the bandsplitting (S1) or the calculation the cross correlation (S2) to the pitch-cycle waveforms which are simply clipped from the speech unit, and applying the weights for the individual pitch-cycle waveforms when overlap-adding the band pitch-cycle waveforms (S3).

### Second Embodiment

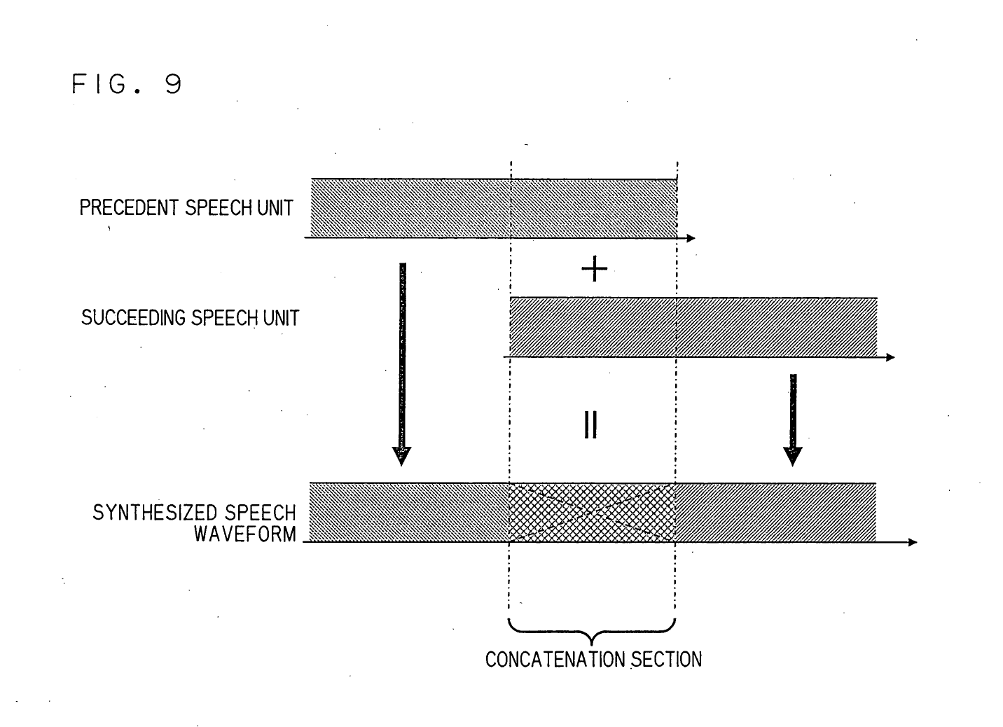

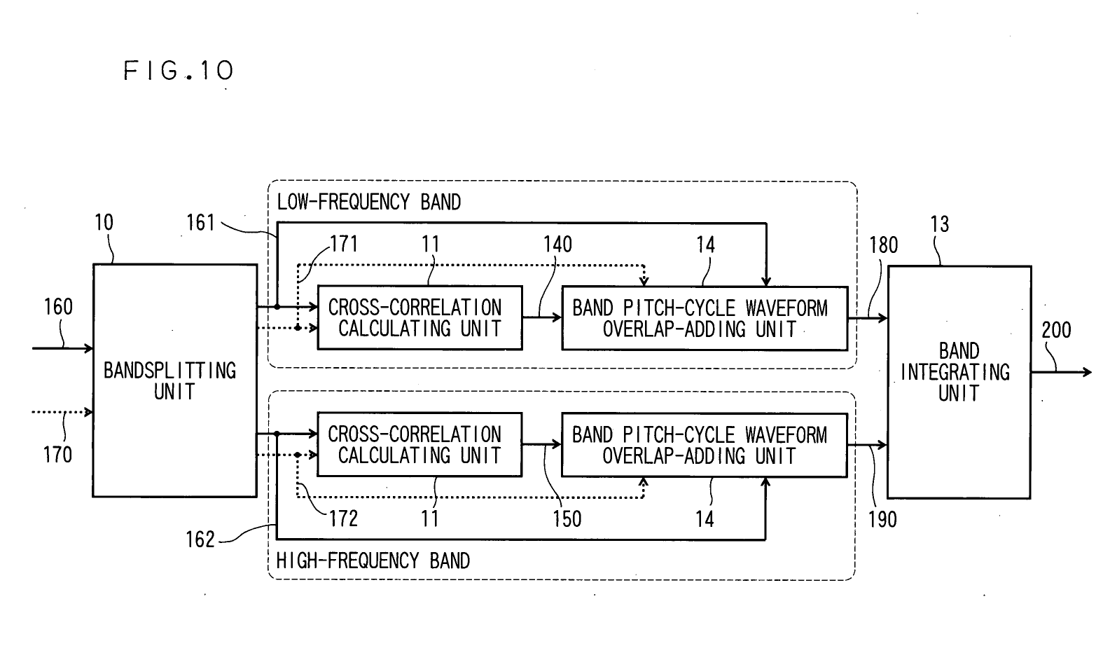

Referring now to FIG. 9 and FIG. 10, a concatenative speech synthesizer as a speech synthesis apparatus according to a second embodiment of the invention will be described.

The second embodiment is characterized in that in a case in which the speech units are not decomposed into the pitch-cycle waveforms and are concatenated as is to generate a synthetic speech waveform, the plurality of speech units are overlap-added in the direction of the time axis with small phase displacement with respect to the each other.

In other words, the speech unit modifying/concatenating portion 22 in FIG. 2 outputs the synthesized speech waveform 102 without decomposing the speech unit 101 selected by the speech unit selecting unit 21 into pitch-cycle waveforms, but by modifying the same such as to change the power considering modification on the basis of the entered prosody information or the weighting at the time of overlap-addition as needed and concatenating the plurality of speech units by overlap-adding partly or entirely in the concatenation section.

In the description shown below, the process of overlap-adding the precedent speech unit and the succeeding speech unit in the concatenation section as shown in FIG. 9 will be mainly described. Other processes are the same as in the first embodiment and hence the detailed description will be omitted.

### (1) Configuration of Concatenation Section Waveform Generating Unit 1

FIG. 10 shows an example of the configuration of the concatenation section waveform generating unit 1 according to the second embodiment.

The content and flow of the process are basically the same as those in the first embodiment. However, it is different in that the entry is the speech unit waveforms instead of the pitch-cycle waveforms, and the speech unit waveforms are handled in the each process in the bandsplitting unit 10, the cross-correlation calculating unit 11, a band waveform overlap-adding unit 14, and the band integrating unit 13. Here, a case in which a precedent speech unit 160 and succeeding speech unit 170 are concatenated will be described as an example.

### (1-1) Bandsplitting Unit 10

The bandsplitting unit 10 splits the precedent speech unit 160 and the succeeding speech unit 170 into two frequency bands; the low-frequency band and the high-frequency band, and generates band speech units 161, 162, 171, and 172 thereof, respectively.

### (1-2) Cross-Correlation Calculating Unit 11

The cross-correlation calculating unit 11 calculates the cross correlations of the individual band speech units of the low-frequency band and the high-frequency band separately, and determines the overlap-added positions 140 and 150 where a high cross correlation of the band speech units from the two speech units to be overlap-added is achieved, that is, where the displacement of the phases in the each band is small.

For example, when the second half portion of the precedent speech unit and the first half portion of the succeeding speech unit are overlap-added at the concatenation portion, the overlap-added position 140 in the low-frequency area is determined by calculating the cross correlation while assuming that the first half portion of the band speech unit 171 from the succeeding speech unit is overlap-added on the speech waveform of the second half portion of the band speech unit 161 from the precedent speech unit, and calculating a position where the highest cross correlation is obtained in a certain search range.

### (1-3) Band Waveform Overlap-Adding Unit 14

The band waveform overlap-adding unit 14 overlap-adds the band speech units according to the overlap-added positions 140 and 150 determined by the cross-correlation calculating unit 11 for the each band, and outputs band overlap-added speech units 180 and 190 which are waveforms obtained by overlap-adding components of the speech units to be concatenated for the each band.

### (1-4) Band Integrating Unit 13

The band integrating unit 13 integrates band overlap-added speech units 180 and 190 which are overlap-added by the each band, and outputs a speech waveform 200 at the concatenation portion.

### (2) Advantages

As described thus far, according to the second embodiment, the phase displacement between the speech units at the concatenation portion may be reduced in all the frequency bands by applying the same process as in the first embodiment to the speech units when overlap-adding the plurality of speech units at the concatenation portion.

In other words, at the concatenation portion, a waveform having an in-between spectrum between the precedent speech unit and the succeeding speech unit and having a small distortion due to the phase difference is generated. Therefore, there is less discontinuity of spectrum change, and deterioration of the sound quality due to the process such as the phase-zeroization is avoided and, consequently, a clear and smooth synthesized speech may be generated.

### (3) Modifications

### (3-1) Modification 1

In the first and second embodiments shown above, the overlap-added position is determined by calculating the cross correlation of the band speech units (or band pitch-cycle waveforms) to be overlap-added for the individual frequency bands by the cross-correlation calculating unit 11. However, the invention is not limited thereto.

For example, it is also possible to calculate the phase spectrums for the individual band speech units (or the band pitch-cycle waveform) to be overlap-added and determine the overlap-added position on the basis of the difference in phase spectrums instead of the cross correlation calculating unit 11. In this case, the band speech units (or the band pitch-cycle waveforms) are shifted and overlap-added so as to reduce the difference between these phase spectrums, so that a waveform having a small distortion due to the phase difference is generated.

### (3-2) Modification 2

The first and second embodiments shown above employs the configuration in which the overlap-added band speech unit (or the overlap-added band pitch-cycle waveforms) obtained by overlap-adding the plurality of band speech units (or the band pitch-cycle waveforms) according to the determined overlap-added position is generated for each band, and then the overlap-added band speech units (or the overlap-added band pitch-cycle waveforms) of these bands are integrated respectively. However, the process procedure of the invention is not limited thereto.

In other words, the order of the process to overlap-add the plurality of speech units (or the pitch-cycle waveforms) used at the concatenation portion and the process to integrate the bands is not limited to the modifications shown above.

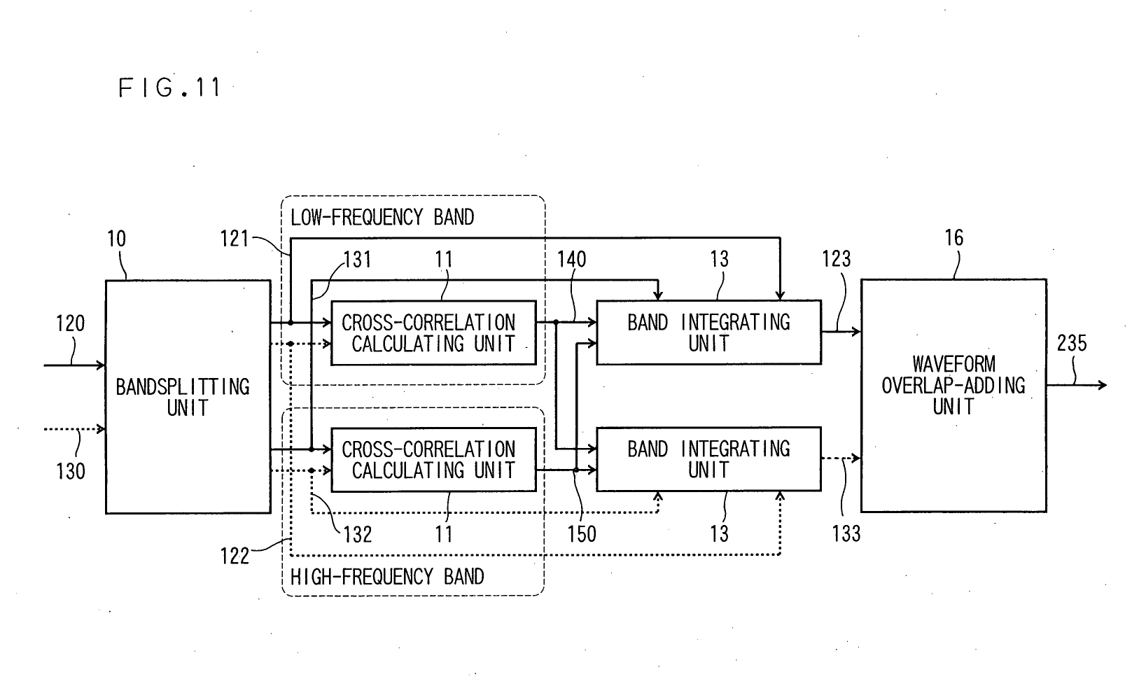

For example, as shown in FIG. 11, it is also possible to firstly shift and integrate the band pitch-cycle waveforms according to the overlap-added position determined by the each band to generate pitch-cycle waveforms 123 and 133 having small phase displacement and having the components of all the frequency bands in the each band for the pitch-cycle waveforms 120 and 130 to be overlap-added at the concatenation portion, and then overlap-add these pitch-cycle waveforms 123 and 133 to generate the concatenation section pitch-cycle waveform 235 having a small distortion due to the phase difference in all the frequency band.

### (3-3) Modification 3

In the first and second embodiments shown above, the two speech waveforms of the precedent speech unit and the succeeding speech unit at the concatenation portion are overlap-added. However, the invention is not limited thereto.

For example, it is also possible to weight and overlap-add three or more speech units. In this case, a speech waveform having a small distortion due to the phase difference is generated by overlap-adding band speech units (or band pitch-cycle waveforms) of speech units except one on a remaining one band speech unit (or band pitch-cycle waveform) of a certain speech unit while shifting so as to reduce the phase displacement by the each band.

### (3-4) Modification 4

In the first and second embodiments described above, the process of bandsplitting is performed both for the precedent speech unit and the succeeding speech unit to be overlap-added at the concatenation portion. However, the invention is not limited thereto.

In the case of the speech waveform delimited to have a certain length, since the correlation between the waveforms in the respective frequency bands is low, almost the same advantages as the above-described embodiments are achieved simply by bandsplitting the speech unit in only one of the precedent speech unit and the succeeding speech unit.

For example, by bandsplitting only the succeeding speech unit and searching the overlap-added position at which a high correlation between the band speech unit of the succeeding speech unit and the precedent speech unit having the components of all the frequency bands is obtained, the phase displacement of the each band is reduced, and the amount of calculation is reduced by an amount corresponding to the elimination of the bandsplitting process for the precedent speech unit.

### Third Embodiment

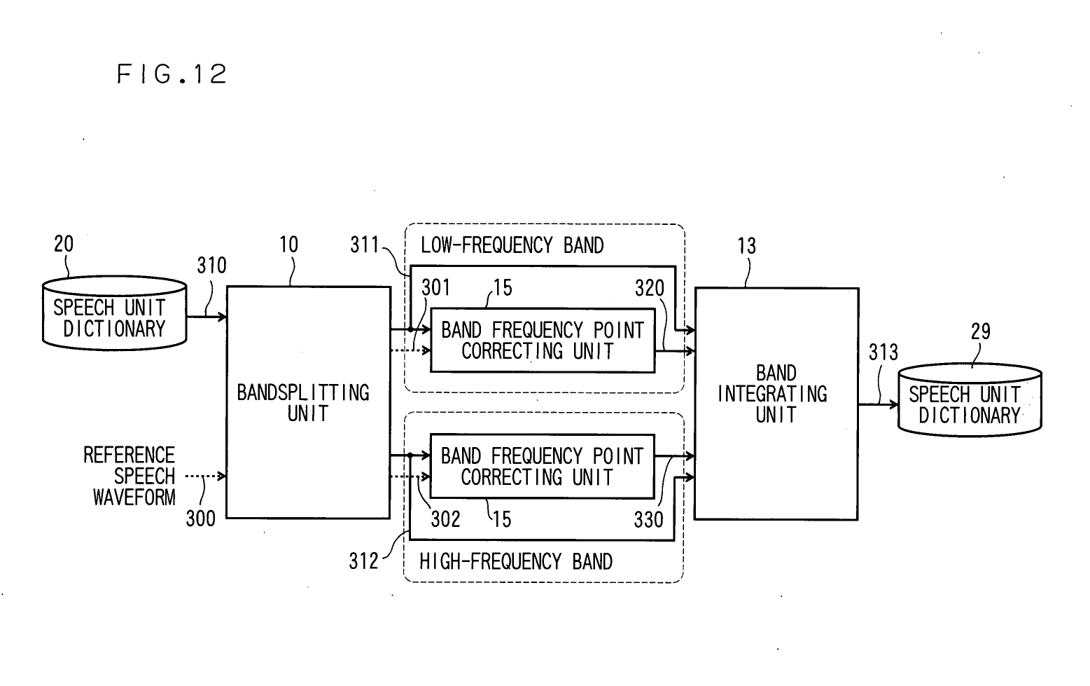

Referring now to FIG. 12 to FIG. 14, a speech unit dictionary creating apparatus as a speech processing apparatus according to a third embodiment of the invention will be described.

### (1) Configuration of Speech Unit Dictionary Creating Apparatus

FIG. 12 shows an example of the configuration of the speech unit dictionary creating apparatus.

This speech unit dictionary creating apparatus includes the entry speech unit dictionary 20, the bandsplitting unit 10, a band reference point correcting unit 15, the band integrating unit 13, and an output speech unit dictionary 29.

### (1-1) Entry Speech Unit Dictionary 20

The entry speech unit dictionary 20 stores a large amount of speech units. Here, a case in which a voiced sound speech unit includes at least one pitch-cycle waveform will be described as an example.

### (1-2) Bandsplitting Unit 10

The bandsplitting unit 10 splits a pitch-cycle waveform 310 in a certain speech unit in the entry speech unit dictionary 20 and a reference speech waveform 300 set in advance into a plurality of frequency bands, and generates pitch-cycle waveforms 311 and 312 and band reference speech waveforms 301 and 302 for the respective bands.

Here, a case of splitting into two bands; the high-frequency band and the low-frequency band using the high-pass filter and the low-pass filter as in the embodiments shown above will be described as an example.

The pitch-cycle waveform 310 and the reference speech waveform 300 respectively have a reference point as described above, and when they are synthesized, a synthesized speech is generated by overlap-adding the pitch-cycle waveforms while aligning the reference points with the target pitch mark positions.

The band pitch-cycle waveform and the band reference speech waveform split into the individual bands are assumed to have the position of the reference point the waveform before the bandsplitting as the band reference point.

### (1-3) Band Reference Point Correcting Unit 15

The band reference point correcting unit 15 corrects the band reference point of the band pitch-cycle waveform in the each band so that the highest cross correlation between the band reference speech waveform and the band pitch-cycle waveform is obtained and outputs a corrected band reference points 320 and 330.

### (1-4) Band Integrating Unit 13

The band integrating unit 13 integrates the band pitch-cycle waveforms 311 and 312 on the basis of the corrected band reference points 320 and 330 and outputs a pitch-cycle waveform 313 obtained by correcting the phase of each band of the original pitch-cycle waveform 310.

### (2) Process of Speech Unit Dictionary Creating Apparatus

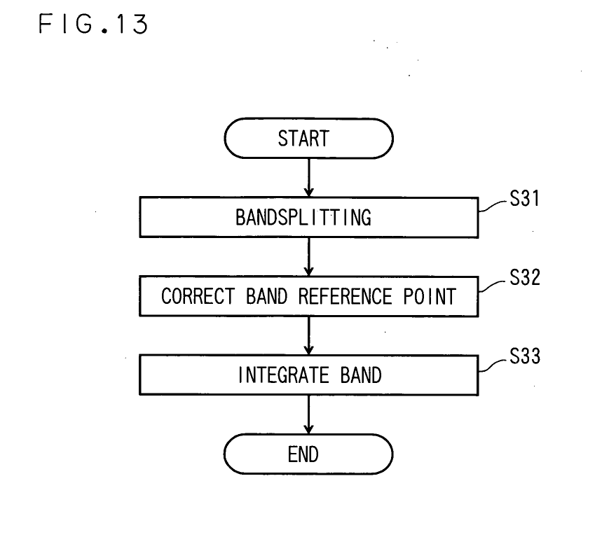

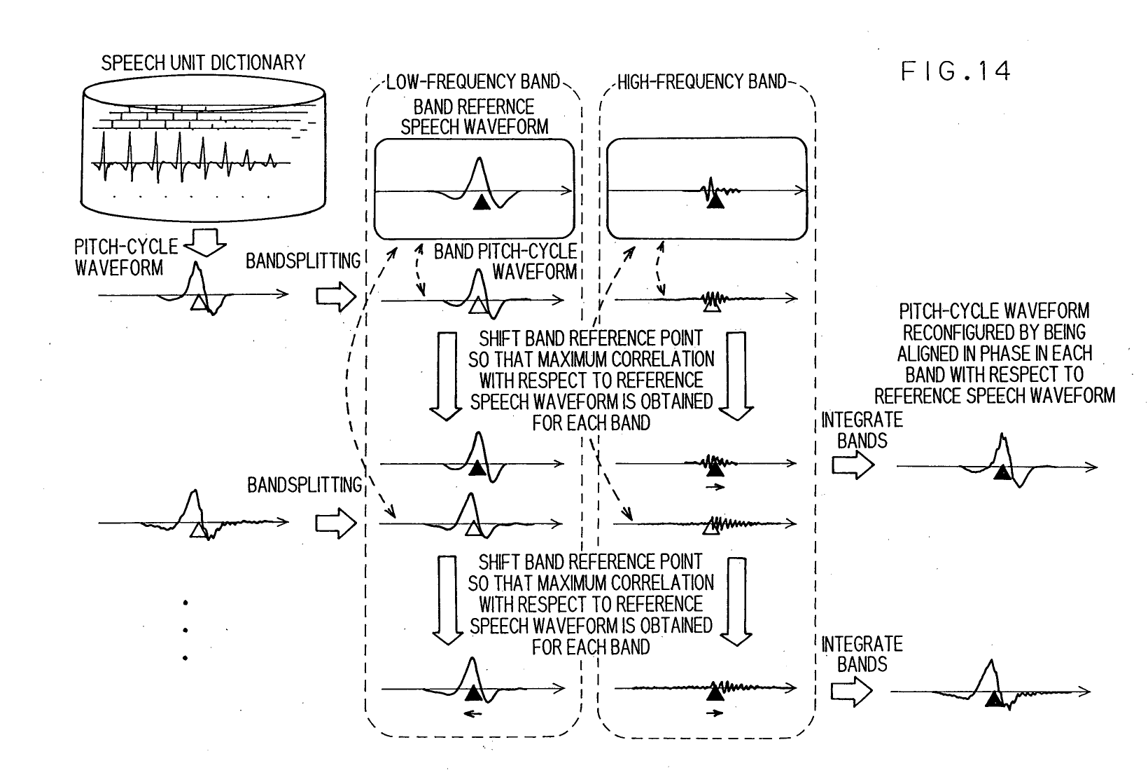

Referring now to a flowchart in FIG. 13 and FIG. 14 schematically showing the operation of the third embodiment, the process of the speech unit dictionary creating apparatus will be described in detail.

### (2-1) Step S31

In Step S31, the bandsplitting unit 10 splits the pitch-cycle waveform 310 in one speech unit contained in the entry speech unit dictionary 20 and the preset reference speech waveform 300 into waveforms of two bands; the low-frequency band and the high-frequency band, respectively.

The term “reference speech waveform” here means a speech waveform used as a reference for minimizing the phase displacement between the speech units (pitch-cycle waveforms) contained in the entry speech unit dictionary 20 as much as possible, and includes signal components of all the frequency bands to be aligned in phase.

As an example, it is assumed to be obtained by calculating a centroid of all the pitch-cycle waveforms contained in the entry speech unit dictionary 20 and selecting a pitch-cycle waveform which is the nearest to the centroid from the entry speech unit dictionary 20.

The reference speech waveform may be stored in the entry speech unit dictionary 20 in advance.

As described above, the band pitch-cycle waveforms 311 and 312 are generated from the pitch-cycle waveform 310 and the band reference speech waveforms 301 and 302 are generated from the reference speech waveform 300, and then the procedure goes to Step S32 in FIG. 13.

### (2-2) Step S32

In Step S32, the band reference point correcting unit 15 corrects the band reference point of the band pitch-cycle waveform so that the higher cross correlation between the band reference speech waveform and the band pitch-cycle waveform is obtained in the each band, and outputs the corrected band reference points 320 and 330.

In other words, in the same manner as the cross-correlation calculating unit 11 described in the first embodiment, the cross correlation between the band pitch-cycle waveform and the band reference speech waveform is calculated by the each band, and the shift position in a certain search range where the high cross correlation is obtained, that is, the shift position where a small phase displacement of the band pitch-cycle waveform with respect to the band reference speech waveform is obtained is searched by the each band to correct the band reference point of the band pitch-cycle waveform. As shown in FIG. 14, correction is made for the each of the low-frequency band and the high-frequency band by shifting the band reference point of the band pitch-cycle waveform to a position at which the correlation with respect to the band reference speech waveform is maximized.

As described above, the corrected band reference points 320 and 330 obtained by correcting the band reference point of the band pitch-cycle waveform are outputted from the each band, and then the procedure goes to Step S33 in FIG. 13.

### (2-3) Step S33

In Step S33, the band integrating unit 13 integrates the band pitch-cycle waveforms 311 and 312 on the basis of the corrected band reference points 320 and 330, and outputs the pitch-cycle waveform 313 obtained by correcting the phase of the original pitch-cycle waveform 310 by the each band.

In other words, as shown in FIG. 14, the pitch-cycle waveform which is reduced in phase displacement with respect to the reference speech waveform in all the frequency bands is reconfigured by integrating the band pitch-cycle waveforms as the components of the individual bands while aligning the band reference point corrected so as to obtain the high correlation with respect to the band reference speech waveform in the each band.

By applying the process as described above in sequence to the pitch-cycle waveforms of the speech units contained in the entry speech unit dictionary 20, the output speech unit dictionary 29 containing the speech units having smaller phase displacement with respect to a certain reference speech waveform is created. By using this dictionary in the concatenative speech synthesizer as shown in FIG. 2, the synthesized speech is generated.

### (3) Advantages

As described thus far, according to the third embodiment, by splitting the each pitch-cycle waveform of the speech unit contained in the entry speech unit dictionary 20 a plurality of frequency bands by the bandsplitting unit 10, correcting the reference point so as to reduce the phase displacement with respect to the reference speech waveform by the each band by the band reference point correcting unit 15, and reconfiguring the pitch-cycle waveform so as to align the reference point corrected by the band integrating unit 13, the phase displacement with respect to a certain reference speech waveform may be reduced in all the frequency bands.

Therefore, the each pitch-cycle waveform of the speech unit contained in the output speech unit dictionary 29 has a small phase displacement with respect to the certain reference speech waveform and, consequently, the mutual phase displacement of the speech units is reduced in all the frequency bands.

In other words, by using the speech unit dictionary applied with the process according to the third embodiment for the concatenative speech synthesizer, the phase displacement between the speech units is reduced in all the frequency bands only by overlap-adding the each speech unit (pitch-cycle waveform) according to the reference point without adding a specific process such as the phase alignment when overlap-adding the plurality of speech units in the concatenation portion, and a waveform having a small distortion due to the phase difference may be generated at the concatenation portion as well.

The deterioration of the sound quality which is a problem arising when the phase is forcedly aligned by shaping the original phase information by the process such as phase zeroising does not occur. In other words, even when the limit of the throughput in synthesis is strict, generation of clear and smooth synthesized speech having less discontinuity of spectrum change caused by the phase displacement of the speech units to be overlap-added at the concatenation portion is achieved without adding a new process on-line.

### (4) Modification

### (4-1) Modification 1

In the third embodiment shown above, the speech unit dictionary of voiced sound includes at least one pitch-cycle waveform, and the phase alignment of the each pitch-cycle waveform with the reference speech waveform is performed. However, the configuration of the speech unit is not limited thereto.

For example, when the speech unit is a speech waveform in the unit of phoneme, and has a reference point for overlap-adding the speech unit in the direction of the time axis for synthesis, it is also possible to apply the process shown above so as to obtain a small phase displacement with respect to a certain reference speech waveform in all the frequency bands for a section which is supposed to be overlap-added over the entire speech unit or at the concatenation portion to reduce the phase displacement between the speech units contained in the speech unit dictionary.

### (4-2) Modification 2

In the third embodiment shown above, the reference speech waveform is a pitch-cycle waveform which is the nearest to the centroid of all the pitch-cycle waveforms contained in the entry speech unit dictionary 20. However, the invention is not limited thereto.

Other waveforms are applicable as long as it contains the signal components of the frequency band to be aligned in phase and is not deviated extremely to the speech unit (or the pitch-cycle waveform) as a target of phase alignment. For example, the centroid of all the pitch-cycle waveforms in the speech unit dictionary by itself may be used.

### (4-3) Modification 3

In the third embodiment shown above, a process of phase alignment is performed for a certain kind of reference speech waveform. However, the invention is not limited thereto.

For example, a plurality of different kinds of reference speech waveform may be used, for example, for the each phonological environment. However, it is preferable that the sections (or the pitch-cycle waveform) of the speech units to be concatenated having a possibility to be concatenated (overlap-added at the concatenation portion) at the time of synthesis are aligned in phase using the same reference speech waveform.

### (4-4) Modification 4

The third embodiment shown above employs a configuration in which the bandsplitting process is performed also for the reference speech waveform. However, the invention is not limited thereto.

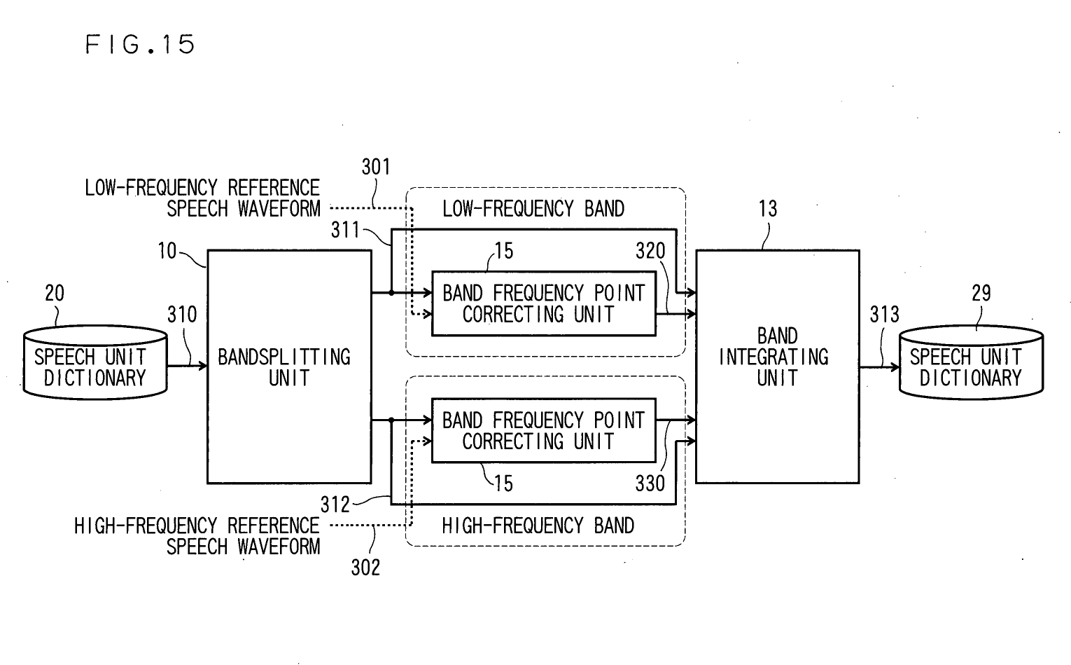

For example, as shown in FIG. 15, it is also possible to prepare the band reference speech waveforms respectively for the low-frequency band and the high-frequency band in advance and use the same as entry for subsequent processes.

### (4-5) Modification 5

In the third embodiment shown above, alignment is performed (the phase displacement is reduced) by shifting the reference point provided to the speech unit (or the pitch-cycle waveform). However, the invention is not limited thereto.

For example, the same effects are achieved by fixing the reference point at the center of the speech unit (or the pitch-cycle waveform) and shifting the waveform, for example, by padding zero at the ends of the waveform.

### (4-6) Modification 6

In the third embodiment shown above, the band reference point of the each band pitch-cycle waveform is determined by calculating the cross correlation between the band reference speech waveform and the band pitch-cycle waveform by the band reference point correcting unit 15 for the each frequency band. However, the invention is not limited thereto.

For example, it is also possible to calculate the phase spectrum for the each band pitch-cycle waveform (or the band speech unit) and the band reference speech waveform and determine the each band reference point on the basis of the difference in phase spectrum. In this case, the phase displacement with respect to the reference speech waveform may be reduced in all the frequency bands by shifting the each band pitch-cycle waveform (or the band speech unit) so as to reduce the difference in phase spectrum therebetween.

### (4-7) Modification 7

In the third embodiment shown above, the each band reference point is determined by correcting the reference points contained in the entry speech unit dictionary 20. However, the invention is not limited thereto.

For example, when the reference point is not provided to the pitch-cycle waveform (or the speech unit) in the entry speech unit dictionary 20, a pitch-cycle waveform (or a speech unit) having a small phase displacement with respect to the reference speech waveform in all the frequency bands may be generated by setting, for example, the center point of the band reference speech waveform as a new band reference point for the position where an extremely high or a maximum coefficient of cross correlation is obtained between the each band pitch-cycle waveform (or the band speech unit) and the band reference speech waveform or the position where an extremely small or a minimum difference in phase spectrum is obtained, and shifting to align with the band reference point of the each band and integrating the same by the band reference point correcting unit 15 in FIG. 12 or FIG. 15.

### (4-8) Modification 8

In the first, second and third embodiments shown above, the speech unit (or the pitch-cycle waveform) is split into two bands; the high-frequency band and the low-frequency band using the high-pass filter and the low-pass filter when splitting the band. However, the invention is not limited thereto, and the speech unit (or the pitch-cycle waveform) may be split into three or more bands and the band widths of these bands may be different from each other.

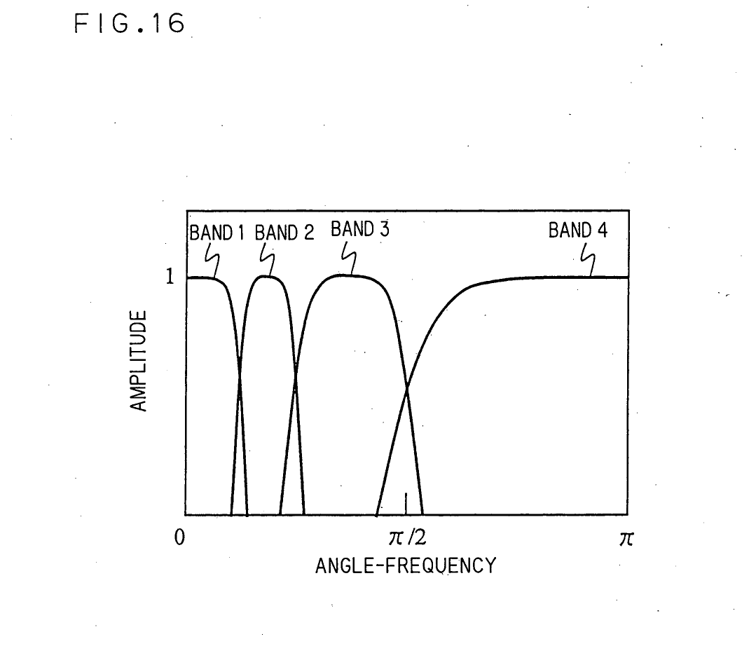

For example, it may be split into four bands having different band widths as shown in FIG. 16. In this case, the effective bandsplitting is achieved by reducing the band width on the low-frequency band side.

### (4-9) Modification 9

In the first, second and third embodiments shown above, the phase alignment is performed for all the frequency bands applied with the bandsplitting. However, the invention is not limited thereto.

For example, it is also possible to split the speech unit (or the pitch-cycle waveform) into a plurality of bands and apply the above-described process only for band speech units (or the band pitch-cycle waveforms) in the low- to medium-frequency band for reducing the phase displacement while leaving the high-frequency components having relatively random phase untouched.

### (4-10) Modification 10

It is also possible to change the range to shift the reference point or the waveform to reduce the phase displacement (the search range for calculating the cross correlation or the difference in phase spectrum) on the band-to-band basis.

### (Modification)

The invention is not limited to the above-described embodiments as is, and the components may be modified and embodied without departing from the scope of the invention in the stage of implementation.

The invention may be modified in various modes by combining the plurality of components disclosed in the embodiments as needed.

For example, some components may be eliminated from all the components shown in the embodiments. Alternatively, the components in the different embodiments may be combined as needed.

What is claimed is:

1. A speech processing apparatus configured to overlap-add a first speech waveform as a part of a first speech unit and a second speech waveform as a part of a second speech unit to concatenate the first speech unit and the second speech unit, comprising:
a splitting unit configured to split the first speech waveform into a plurality of frequency bands to generate a band speech waveform A being a component of each frequency band, and split the second speech waveform into a plurality of frequency bands to generate a band speech waveform B being a component of each frequency band;
a position determining unit configured to determine an overlap-added position between the band speech waveform A and the band speech waveform B by the each frequency band so that a high cross correlation between the band speech waveform A and the band speech waveform B is obtained or so that a small difference in phase spectrum between the band speech waveform A and the band speech waveform B is obtained; and
an integrating unit configured to overlap-add the band speech waveform A and the band speech waveform B by the each frequency band on the basis of the overlap-added position and integrate overlap-added band speech waveforms in the plurality of frequency bands over all the plurality of frequency bands to generate a concatenated speech waveform.

2. The apparatus according to claim 1, wherein the speech waveform is a pitch-cycle waveform extracted from a voiced sound portion.

3. The apparatus according to claim 1, wherein the position determining unit determines the position to shift the band speech waveform A or the band speech waveform B as the position to be overlap-added so that an extremely high or a maximum coefficient of cross correlation is obtained between the band speech waveform A and the band speech waveform B.

4. The apparatus according to claim 1, wherein the position determining unit determines the position to shift the band speech waveform A or the band speech waveform B as the position to be overlap-added so that an extremely small or a minimum difference in phase spectrum is obtained between the band speech waveform A and the band speech waveform B.

5. A speech processing apparatus comprising:
a first dictionary including a plurality of speech waveforms and reference points to be overlap-added when concatenating the speech waveforms stored therein for each speech waveform;
a splitting unit configured to split the each speech waveform into a plurality of frequency bands and generate a band speech waveform as a component of the each frequency band;
a reference waveform storing unit configured to store a band reference speech waveform each containing a signal component of the each frequency band;
a position correcting unit configured to correct the reference point for the band speech waveform so as to achieve a high cross correlation between the band speech waveform and the band reference speech waveform or so as to achieve a small difference in phase spectrum between the band speech waveform and the band reference speech waveform to obtain a band reference point for the band speech waveform; and
a reconfiguring unit configured to shift the band speech waveform to align the position of the band reference point and integrate shifted band speech waveforms over all the plurality of frequency bands to reconfigure the speech waveform.

6. The apparatus according to claim 5, wherein the speech waveform is a pitch-cycle waveform extracted from a voiced sound portion.

7. The apparatus according to claim 5, wherein the position correcting unit corrects the reference point so that an extremely high or a maximum coefficient of the cross correlation is obtained between the band speech waveform and the band reference speech waveform and obtains the band reference point.

8. The apparatus according to claim 5, wherein the position correcting unit corrects the reference point so that an extremely small or a minimum difference in phase spectrum is obtained between the band speech waveform and the band reference speech waveform and obtains the band reference point.

9. The apparatus according to claim 5, wherein the reference waveform storing unit stores the band reference speech waveform provided from the outside or stores the band reference speech waveform generated using the speech waveform stored in the first dictionary.

10. The apparatus according to claim 5, wherein the reconfiguring unit generates a second dictionary storing the reconfigured speech waveform and a new reference point corresponding to the band reference point.

11. A speech processing method configured to overlap-add a first speech waveform as a part of a first speech unit and a second speech waveform as a part of a second speech unit to concatenate the first speech unit and the second speech unit, comprising:
splitting the first speech waveform into a plurality of frequency bands to generate a band speech waveform A being a component of each frequency band, and splitting the second speech waveform into a plurality of frequency bands to generate a band speech waveform B being a component of each frequency band;
determining an overlap-add position between the band speech waveform A and the band speech waveform B by the each frequency band so that a high cross correlation between the band speech waveform A and the band speech waveform B is obtained or so that a small difference in phase spectrum between the band speech waveform A and the band speech waveform B is obtained; and
overlap-adding the band speech waveform A and the band speech waveform B by the each frequency band on the basis of the overlap-added position and integrating overlap-added band speech waveforms in the plurality of frequency bands over all the plurality of frequency bands to generate a concatenated speech waveform.

12. A speech processing method comprising:
splitting a speech waveform into a plurality of frequency bands and generating a band speech waveform as a component of each frequency band from a first dictionary including a plurality of speech waveforms and reference points to be overlap-added when concatenating the speech waveforms stored therein for the each speech waveform;
generating a band reference speech waveform containing a signal component of the each frequency band;
correcting the reference point for the band speech waveform so as to achieve a high cross correlation between the band speech waveform and the band reference speech waveform or so as to achieve a small difference in phase spectrum between the band speech waveform and the band reference speech waveform and obtaining a band reference point for the band speech waveform; and
shifting the band speech waveform to align the position of the band reference point and integrating shifted band speech waveforms over all the plurality of frequency bands to reconfigure the speech waveform.

13. A speech processing program for overlap-adding a first speech waveform as a part of a first speech unit and a second speech waveform as a part of a second speech unit to concatenate the first speech unit and the second speech unit, the program stored in a computer readable medium, and realizing functions of:
splitting the first speech waveform into a plurality of frequency bands to generate a band speech waveform A being a component of each frequency band and, splitting the second speech waveform into a plurality of frequency bands to generate a band speech waveform B being a component of each frequency band;
determining an overlap-added position between the band speech waveform A and the band speech waveform B by the each frequency band so that a high cross correlation between the band speech waveform A and the band speech waveform B is obtained or so that a small difference in phase spectrum between the band speech waveform A and the band speech waveform B is obtained; and
overlap-adding the band speech waveform A and the band speech waveform B by the each frequency band on the basis of the overlap-added position and integrating overlap-added band speech waveforms in the plurality of frequency bands over all the plurality of frequency bands to generate a concatenated speech waveform.

14. A speech processing program stored in a computer readable medium, and realizing functions of:
splitting a speech waveform into a plurality of frequency bands and generating a band speech waveform as a component of each frequency band from a first dictionary including a plurality of the speech waveforms and reference points to be overlap-added when concatenating the speech waveforms stored therein for the each speech waveform;
generating a band reference speech waveform containing a signal component of the each frequency band;
correcting the reference point for the band speech waveform so as to achieve a high cross correlation between the band speech waveform and the band reference speech waveform or so as to achieve a small difference in phase spectrum between the band speech waveform and the band reference speech waveform and obtaining a band reference point for the band speech waveform; and
shifting the band speech waveform to align the position of the band reference point and integrating shifted band speech waveforms over all the plurality of frequency bands to reconfigure the speech waveform.
